(19) United States
(12) Patent Application Publication
(10) Pub. No.: US 2021/0101598 A1
(43) Pub. Date: Apr. 8, 2021

(54) SYSTEM AND METHOD FOR CONTROLLING AND DISTRIBUTING REGENERATIVE BRAKING FORCE IN AUTONOMOUS VEHICLE IN CONSIDERATION OF TRACTIVE RESISTANCE

(71) Applicants: HYUNDAI MOTOR COMPANY, Seoul (KR); KIA MOTORS CORPORATION, Seoul (KR)

(72) Inventor: In-Su KIM, Anyang-si (KR)

(73) Assignees: HYUNDAI MOTOR COMPANY, Seoul (KR); KIA MOTORS CORPORATION, Seoul (KR)

(21) Appl. No.: 16/788,457

(22) Filed: Feb. 12, 2020

(30) Foreign Application Priority Data
Oct. 7, 2019 (KR) 10-2019-0124134

(51) Int. Cl. B60W 30/18; B60L 7/26; B60W 60/00; G16Y 40/10

(52) U.S. Cl. CPC B60W 30/18127; B60L 7/26; B60T 2270/604; G16Y 40/10; B60W 60/00186

(57) ABSTRACT

A system and a method are provided to control and distribute a regenerative braking force in an autonomous vehicle based on a resistance generated to a traveling vehicle. The method includes: a first step of comparing a tractive resistance and a target braking force in a section from an autonomous vehicle acceleration off time point to a first time point in a braking section; and a second step of comparing a sum of the tractive resistance and a maximum regenerative braking force with the target braking force in a section from the first time point to a second time point in the braking section.

### CROSS-REFERENCE TO RELATED APPLICATION

This application claims priority to and the benefit of Korean Patent Application No. 10-2019-0124134, filed on Oct. 7, 2019, the entire contents of which are incorporated herein by reference.

### FIELD

The present disclosure relates to a system and a method for controlling and distributing regenerative braking force in an autonomous vehicle.

### BACKGROUND

The statements in this section merely provide background information related to the present disclosure and may not constitute prior art.

In general, regenerative braking is used to brake a vehicle that travels using an electric motor, i.e., an environmentally-friendly vehicle such as a pure electric vehicle (EV), a hybrid electric vehicle (HEV), and a fuel cell vehicle (FCV).

A regenerative braking system for an environmentally-friendly vehicle converts kinetic energy of the vehicle into electrical energy and stores the electrical energy in a battery during a process of braking the vehicle, and the electrical energy is reused to operate the electric motor when driving the vehicle, thereby improving fuel economy of the vehicle. Here, the environmentally-friendly vehicle may be a vehicle that travels in an autonomous driving mode or a vehicle that travels in a driver mode.

The vehicle, which performs the regenerative braking, requires a cooperative regenerative braking control technology that makes a sum of regenerative braking force generated by a drive motor during the regenerative braking and frictional braking force generated in a brake equal to a target braking force.

In this case, it is desired to appropriately distribute the regenerative braking force generated by rotational resistance and a power generation operation of the drive motor and the frictional braking force applied by the brake.

Meanwhile, there is resistance (hereinafter, referred to as ‘tractive resistance’) generally applied in a direction of hindering the traveling of the vehicle while the vehicle travels. However, we have discovered that if the tractive resistance is not considered during the process of braking the vehicle, a total braking force (a sum of the regenerative braking force and the frictional braking force) becomes higher than the target braking force, which causes braking heterogeneity due to excessive braking force. In addition, because the frictional braking force is generated in advance even in a situation in which the regenerative braking force may be further generated, the effect of improving fuel economy deteriorates.

In the related art, there are several technologies for cooperatively controlling the regenerative braking and the frictional braking, but there is no technology that considers the tractive resistance.

### SUMMARY

The present disclosure provides a method of controlling and distributing regenerative braking force in an autonomous vehicle, thereby achieving an effect of reducing or minimizing braking heterogeneity and improving fuel economy by considering tractive resistance while performing cooperative regenerative braking control on a vehicle being braked.

An exemplary form of the present disclosure provides a method of controlling and distributing regenerative braking force in an autonomous vehicle in consideration of tractive resistance, which controls a braking force distribution to meet target braking force required at respective time points in consideration of tractive resistance determined in real time in a braking section of an autonomous vehicle. The method includes: a first step of comparing, by a comparing unit, the tractive resistance and the target braking force in a section from an autonomous vehicle acceleration off time point to a first time point in the braking section; and a second step of comparing, by the comparing unit, a sum of the tractive resistance and a maximum regenerative braking force with the target braking force in a section from the first time point to a second time point in the braking section.

In one form, a braking force from the autonomous vehicle acceleration off time point to the first time point is controlled so that the tractive resistance is distributed, and a braking force from the first time point to the second time point is controlled so that a sum of the tractive resistance and the regenerative braking force is distributed.

Another exemplary form of the present disclosure provides a system for controlling and distributing regenerative braking force in an autonomous vehicle in consideration of tractive resistance, the system including: an information collecting unit configured to acquire information about an interior and an exterior of an autonomous vehicle; a determination unit configured to determine a tractive resistance based on the information collected by the information collecting unit; a comparison unit configured to compare the tractive resistance and a target braking force or compare a sum of the tractive resistance and a maximum regenerative braking force with a target braking force; and a braking force determining unit configured to determine the tractive resistance as a braking force, determine a sum of the tractive resistance and a regenerative braking force as a braking force, or determine a sum of the tractive resistance, the maximum regenerative braking force, and a frictional braking force as a braking force based on the determination result of the comparison unit.

According to the system and the method for controlling and distributing regenerative braking force in an autonomous vehicle in consideration of tractive resistance according to the exemplary form of the present disclosure, the tractive resistance is considered in real time to meet the target braking force required for the autonomous vehicle, such that the current braking force and the target braking force are equal to each other or present in a constant range. As a result, braking efficiency is increased, braking heterogeneity is reduced or minimized, and a section in which the regenerative braking force is generated is increased.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view schematically illustrating a configuration of a braking system for an autonomous vehicle according to an exemplary form of the present disclosure;

FIG. 2 is a view schematically illustrating a configuration of a brake control unit of the braking system in FIG. 1;

FIG. 3 is a braking diagram illustrating a method of distributing braking force in the related art that does not consider tractive resistance;

FIG. 4 is a braking diagram made by further considering a change in tractive resistance over time from the braking diagram in FIG. 3;

FIG. 5 is a braking diagram illustrating a method of distributing braking force that considers tractive resistance in accordance with the exemplary form of the present disclosure;

FIG. 6 is a braking diagram made by further considering a change in tractive resistance over time from the braking diagram in FIG. 5; and

FIG. 7 is a flowchart illustrating a method of controlling and distributing regenerative braking force in an autonomous vehicle in consideration of tractive resistance according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, exemplary forms of a system and a method for controlling and distributing regenerative braking force in an autonomous vehicle in consideration of tractive resistance according to the present disclosure will be described in detail with reference to the drawings. Terms or words used herein should not be interpreted as being limited to a general or dictionary meaning and should be interpreted as a meaning and a concept which conform to the technical spirit of the present disclosure based on a principle that an inventor can appropriately define a concept of a term in order to describe his/her own present disclosure by the best method.

The present disclosure is characterized in that an autonomous vehicle distributes different braking force for each braking section by considering tractive resistance generated to a traveling vehicle from a braking start time point. In particular, the tractive resistance is generated in all braking sections. There is a problem in that over braking is performed because the tractive resistance is not considered in a general vehicle that is braked only by a driver. Therefore, the present disclosure may be applied to any vehicle that may consider the tractive resistance while distributing the braking force. However, in the present specification, the description will focus on the autonomous vehicle.

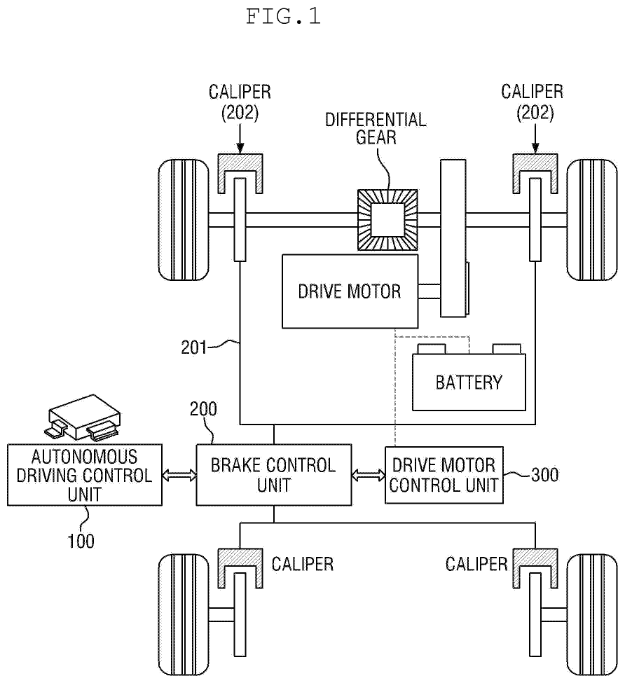

FIG. 1 is a view schematically illustrating a configuration of a braking system for an autonomous vehicle according to an exemplary form of the present disclosure. The autonomous vehicle includes an autonomous driving control unit 100, a brake control unit 200, and a drive motor control unit 300. Each component may be modularized and separated. A control function and a communication function may be performed by an electronic control unit (ECU) separately mounted for each control unit, and functions of the respective control units may be performed by the single ECU. The ECU module may be provided with one or more processors configured to operate by a set program, and the ECU module is configured to perform respective steps of an operating method to be described below.

The autonomous driving control unit 100 has a function of sensing and processing external information acquired while the autonomous vehicle travels and autonomously determines a traveling route by recognizing the surrounding environment when the autonomous vehicle travels even though a driver does not control a brake, a steering wheel, an accelerator pedal, and the like. In addition, when the braking is required, the autonomous driving control unit 100 calculates target braking force and transmits the calculated signal to the brake control unit 200. In addition, the autonomous driving control unit 100 may transmit an acceleration signal to the drive motor control unit 300. The autonomous driving control unit 100 controls the vehicle so that the vehicle travels in an autonomous driving mode. When the autonomous driving mode is switched to a driver mode by a driver, the autonomous driving control unit 100 hands over the driving control authority to the driver.

Meanwhile, the autonomous driving control unit 100 includes an information collecting unit 110. The information collecting unit 110 collects vehicle interior information and vehicle exterior information. Here, the vehicle interior information means information measured by various types of sensors installed in the vehicle, for example, a wheel speed sensor, a yaw rate sensor, a steering angle sensor, a lateral acceleration sensor, and a pedal effort sensor required in the driver mode. In addition, the vehicle exterior information means information collected by RADAR, LIDAR, an image sensor, GPS, a navigation system, a G-sensor, and the like to recognize a state or a lane on a road on which the autonomous vehicle is traveling or to recognize a traveling route of the autonomous vehicle or traveling routes of other vehicles at the periphery of the autonomous vehicle.

According to the exemplary form of the present disclosure, an internet of things (IOT) module mounted in the vehicle is further used to determine the vehicle exterior information. The IOT module is connected to the Internet and may receive various external environment information regarding the vehicle, such as data of states of the roads on which the vehicle travels (e.g., data regarding a degree of sinuosity of the road, obstacles entering the road, etc.), information about a current state of atmosphere, information about positions of traffic signals, information about speed enforcement, information about traffic situations, and information about distances between vehicles.

The information collected by the information collecting unit 110 is stored in a memory unit 120. The memory unit 120 may include various storage media such as a flash memory, a hard disc, a secure digital (SD) card, a random access memory (RAM), a read only memory (ROM), and a web storage.

The brake control unit 200 performs control to generate hydraulic braking pressure based on a target braking force calculation signal from the autonomous driving control unit 100 or a pedal effort signal generated as a driver pushes a brake pedal. Then, hydraulic pressure is transmitted to wheel cylinders installed in respective vehicle wheels through a hydraulic line 201, such that the braking is performed by means of friction between a caliper 202 and a disc.

The drive motor control unit 300 stores electrical energy in a battery when the electrical energy is generated by counter electromotive force of the drive motor in response to an instruction from the autonomous driving control unit 100 or a pedal effort applied to the brake pedal by the driver, thereby controlling the autonomous vehicle to perform the regenerative braking. The drive motor control unit 300 is connected to the autonomous driving control unit 100 and the brake control unit 200 and may transmit and receive control signals.

Meanwhile, the autonomous driving control unit 100, the information collecting unit 110, the memory unit 120, the brake control unit 200, the drive motor control unit 300 may transmit and receive data (information) there between via vehicle networks such as the controller area network (CAN), the media oriented systems transport (MOST) network, the local interconnect network (LIN), the X-by-Wire (Flexray), or the like.

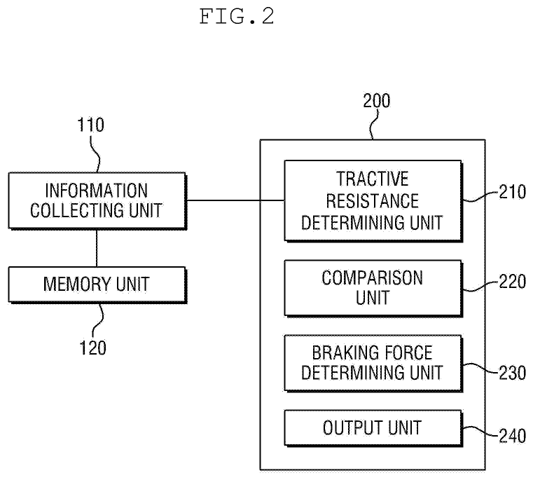

FIG. 2 is a view schematically illustrating a configuration of the brake control unit of the braking system in FIG. 1. The brake control unit 200 includes a tractive resistance determining unit 210, a comparison unit 220, a braking force determining unit 230, and an output unit 240.

The tractive resistance determining unit 210 determines the tractive resistance in real time based on the information collected by the information collecting unit 110. The tractive resistance is resistance applied to hinder the traveling of the autonomous vehicle, and various types of resistance are generated at one time or selectively depending on traveling situations. In the present specification, as the tractive resistance, rolling resistance, air resistance, and gradient resistance will be representatively described. However, because the method of determining the tractive resistance is an already publicly known technology, the method of determining the tractive resistance will be schematically described in the present specification, and the contents of the determination method applicable to the system according to the exemplary form of the present disclosure will be mainly described.

The rolling resistance is resistance generated by the rolling of the vehicle wheel and applied in a direction opposite to the traveling direction. The rolling resistance is generated between the vehicle wheel and the road surface when the autonomous vehicle travels. The rolling resistance is generated by various reasons such as deformation of a tire, unevenness of the road surface, impact, and friction of a vehicle wheel bearing.

A first calculation formula for determining the rolling resistance is as follows.

R_{ROLLING}=μᵣ×W <First Calculation Formula>
Here, μᵣ is a rolling resistance coefficient, and W is a weight of a vehicle.

The information collecting unit 110 may collect information about all elements used for the first calculation formula in order to determine the rolling resistance. For example, the information collecting unit 110 may collect in real time information about air pressure of the wheel by using an air pressure sensor when the information about the air pressure is required to obtain the rolling resistance coefficient. The information collecting unit 110 may collect in real time information about torque signals by using a torque sensor in order to calculate the rolling resistance based on torque of the drive motor.

The air resistance is resistance applied to the vehicle by air when the vehicle travels. The air resistance means a sum total of pressure resistance to a leading edge, vortex flow resistance to a trailing edge, frictional resistance to a surface, additional resistance to components, resistance caused by interference with the ground surface, and the like which are generated when air collides with the vehicle while the vehicle travels.

A second calculation formula for determining the air resistance is as follows.

R_{AIR}=μₐ×A×V <Second Calculation Formula>
Here, μₐ is an air resistance coefficient, A is a front projection area (m²), and V is a traveling speed (Km/h).

The information collecting unit 110 may collect information about all elements used for the second calculation formula in order to determine the air resistance. For example, the information collecting unit 110 collects in real time information about a rotational speed of the wheel by using a wheel speed sensor when information about a speed is required to obtain a speed of the vehicle.

The gradient resistance is resistance applied in a direction against a center of gravity of the vehicle by a component of force in a direction opposite to the gravity when the vehicle is climbing a slope. However, the gradient resistance acts as force for supporting the driving power of the vehicle when the vehicle travels down a hill.

A third calculation formula for determining the gradient resistance is as follows.

R_{GRADIENT}=W×sin θ <Third Calculation Formula>
Here, W is a weight of a vehicle, and θ is an inclination angle of a road on which a vehicle travels.

The information collecting unit 110 may collect information about all elements used for the third calculation formula in order to determine the gradient resistance. For example, the information collecting unit 110 may collect in real time information about the inclination angle by using a G sensor, a camera, or a navigation system.

Meanwhile, a value of the tractive resistance, which is not disclosed in the present specification, may of course be determined by the tractive resistance determining unit 210 based on the information from the information collecting unit 110 as described above. The determination of the tractive resistance may be estimated as a sum of generated resistance.

The comparison unit 220 compares the current braking force with the target braking force required at each time point in a braking section. The braking section is a section from a braking start time point to a braking completion time point. Meanwhile, target braking force lines made by calculating, based on the entire braking section, the target braking force required for the autonomous vehicle at the respective time points in the braking section are indicated in a braking map that represents a relationship between the braking section and the braking force. In addition, current braking force lines made by calculating, based on the entire braking section, the current braking force generated by the autonomous vehicle at the respective time points in the braking section are indicated in the braking map. According to the exemplary form of the present disclosure, various braking maps suitable for braking situations are set in advance and stored in the memory unit 120.

According to the exemplary form of the present disclosure, the braking section includes a first section, a second section, and a third section. Based on the vehicle speed, the braking section is divided into the first section which is a high-speed section to the third section which is a low-speed section.

The first section is a section from the braking start time point to a first time point. Here, the braking start time point may mean a time point at which no acceleration is performed. That is, the braking start time point may be a time point at which the drive motor control unit 300 cannot receive an acceleration signal from the autonomous driving control unit 100 or the driver does not push an accelerator pedal. The second section is a section from the first time point to a second time point. Here, the first time point is a time point at which the regenerative braking force is generated, and the second time point is a time point at which the frictional braking force is generated. The third section is a section from the second time point to the braking completion time point.

Meanwhile, in the exemplary form of the present disclosure, coast regenerative braking force may be generated in a state in which no acceleration is performed. Hereinafter, in the present specification, the regenerative braking force including the coast regenerative braking force will be described.

The comparison unit 220 selects a braking map suitable for the current braking situation among the braking maps stored in the memory unit 120 and compares in real time the current braking force with the target braking force required for the respective braking time points in the selected braking map. Here, the current braking situation may be determined based on the information collected by the information collecting unit 110. For example, in a situation in which rapid braking is currently required, the braking map having the target braking force line with a steep gradient may be selected.

The braking force determining unit 230 determines in real time the current braking force to meet the target braking force in the first section, the second section, and the third section. Here, the target braking force is increased as the braking time passes.

In the first section, the braking force determining unit 230 determines the tractive resistance as the current braking force even though the tractive resistance is higher than the target braking force. That is, in the first section, other than the tractive resistance, no separate braking force is generated even though the braking signal is transmitted to the brake control unit 200 from the autonomous driving control unit 100 or the driver pushes the brake pedal.

In the second section, when the comparison unit 220 determines that the current braking force (tractive resistance) is lower than the target braking force, the braking force determining unit 230 generates additional regenerative braking force and determines a sum of the tractive resistance and the regenerative braking force as the current braking force. In this case, the regenerative braking force is increased just to a predetermined maximum regenerative braking force.

In the third section, when the comparison unit 220 determines that the current braking force (the sum of the tractive resistance and the maximum regenerative braking force) is lower than the target braking force, the braking force determining unit 230 generates additional frictional braking force and determines a sum of the tractive resistance, the maximum regenerative braking force, and the frictional braking force as the current braking force. In this case, the frictional braking force is increased until the time point at which the braking is completed.

When the current braking force is determined by the braking force determining unit 230, the output unit 240 outputs a braking signal that matches the determined braking force.

As described above, the system for controlling and distributing regenerative braking force in an autonomous vehicle in consideration of tractive resistance according to the exemplary form of the present disclosure distributes the braking force in consideration of the tractive resistance generated in all of the braking sections.

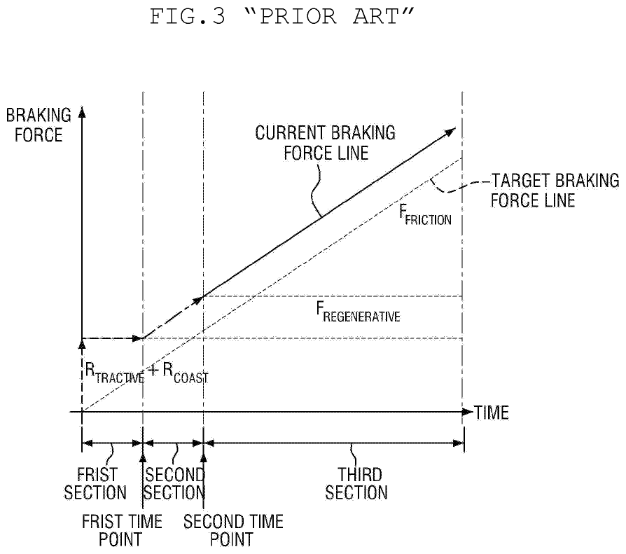

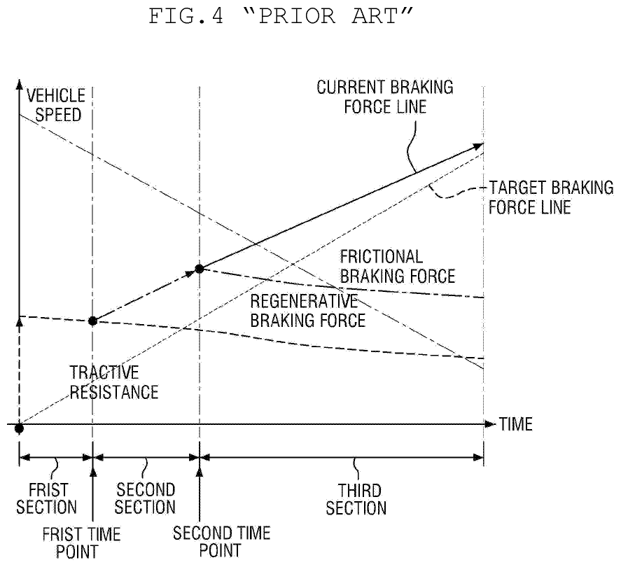

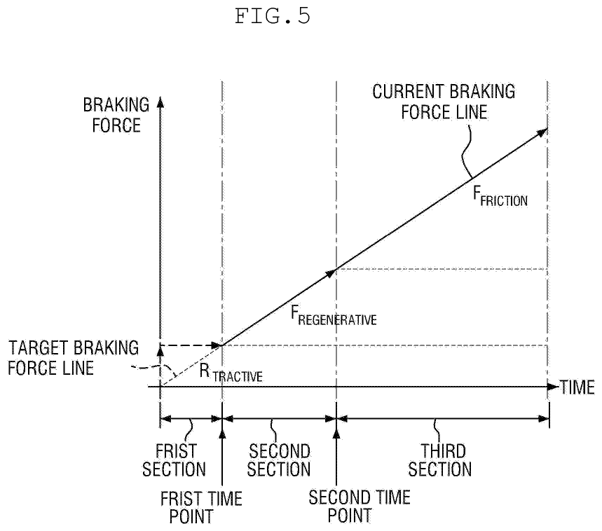

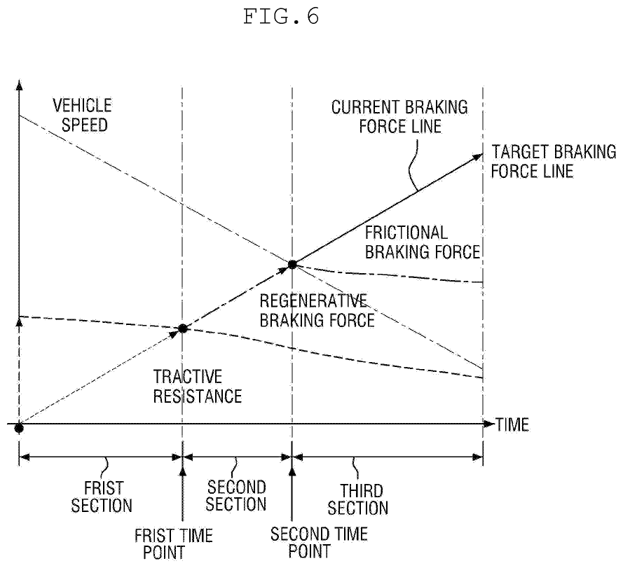

FIG. 3 is a braking diagram illustrating a method of distributing braking force in the related art that does not consider tractive resistance, FIG. 4 is a braking diagram made by further considering a change in tractive resistance over time from the braking diagram in FIG. 3, FIG. 5 is a braking diagram illustrating a method of distributing braking force that considers tractive resistance in accordance with the exemplary form of the present disclosure, and FIG. 6 is a braking diagram made by further considering a change in tractive resistance over time from the braking diagram in FIG. 5.

FIGS. 3 and 4 are braking diagrams, that is, braking maps illustrating the distribution of the braking force in the braking section in a state in which the tractive resistance is not considered. Here, FIG. 3 illustrates a case in which the tractive resistance generated at the braking start time point is constant until the braking completion time point, and FIG. 4 illustrates a case in which the tractive resistance is not constant.

Meanwhile, the graphs in FIGS. 3 and 4 are to be compared with the exemplary forms of the present disclosure as follows.

Referring to FIG. 3, in the first section, the constant tractive resistance is generated at the braking start time point. In the first section, because the tractive resistance is higher than the target braking force, the current braking force is controlled to be the tractive resistance regardless of the braking signal from the autonomous driving control unit 100 or the pedal effort signal of the driver. It can be seen that the current braking force line is constant in the first section illustrated in FIG. 3.

A vehicle, which does not consider the tractive resistance, is controlled to generate additional regenerative braking force in consideration of insufficient braking force at the first time point. Therefore, the current braking force, which is the sum of the tractive resistance and the regenerative braking force, is increased to correspond to the target braking force at the respective time points. It can be seen that the current braking force line and the target braking force line are equal in gradient in the second section illustrated in FIG. 3.

The vehicle, which does not consider the tractive resistance, is controlled to generate additional frictional braking force in consideration of insufficient braking force at the second time point because the regenerative braking force cannot be increased any further. Therefore, the current braking force, which is the sum of the tractive resistance, which is the current braking force, the maximum regenerative braking force, and the frictional braking force is increased to correspond to the target braking force at the respective time points. It can be seen that the current braking force line and the target braking force line are equal in gradient in the third section illustrated in FIG. 3.

Meanwhile, the actual tractive resistance is changed as the braking time passes. For example, the tractive resistance is changed due to a decrease in vehicle speed and air resistance as the braking is performed, or the tractive resistance is changed as the gradient resistance is still applied as the braking is performed on an upward slope. In the exemplary form of the present disclosure, FIGS. 4 and 6 illustrate cases in which the tractive resistance is decreased as the braking time passes.

Referring to FIG. 4, the tractive resistance is decreased in the first to third sections as time passes. The vehicle is controlled to generate additional regenerative braking force at the first time point, and the current braking force, which is the sum of the tractive resistance and the regenerative braking force, is gradually decreased at the respective time points due to the decrease in tractive resistance. In addition, the vehicle is controlled to generate additional frictional braking force at the second time point, and the current braking force, which is the sum of the tractive resistance, the maximum regenerative braking force, and the frictional braking force, is gradually decreased at the respective time points due to the decrease in tractive resistance.

That is, the vehicle, which does not consider the tractive resistance, cannot compensate for the tractive resistance decreased over time, and as a result, the current braking force line and the target braking force line are not equal in gradient. As illustrated in FIGS. 3 and 4, if the tractive resistance is not considered, the current braking force is always higher than the target braking force, and over braking occurs, and as a result, there is a problem in that braking heterogeneity is caused and felt by the driver and braking efficiency deteriorates. Therefore, in the exemplary form of the present disclosure, the tractive resistance is considered to prevent the above-mentioned problem.

Referring to FIG. 5, the constant tractive resistance is generated at the braking start time point in the first section. This configuration is the same as the configuration described with reference to FIG. 3.

The autonomous vehicle, which considers the tractive resistance, is controlled to generate additional regenerative braking force in consideration of insufficient braking force at the first time point in the second section. Here, based on the braking diagram, the first time point may be defined as a time point at which the current braking force line (tractive resistance line) and the target braking force line meet together. Thereafter, the current braking force, which is the sum of the tractive resistance and the regenerative braking force, is controlled to be equal to the target braking force at the respective time points. Then, the braking force required for the autonomous vehicle and the target braking force are equal to each other, such that an effect of solving braking heterogeneity and improving braking efficiency is achieved. In addition, in the second section, the current braking force line and the target braking force line are equal in gradient to each other, such that the section in which the regenerative braking force is generated is increased. This configuration may be recognized by comparing lengths of the current braking force lines in the second section illustrated in FIGS. 3 and 5.

The autonomous vehicle, which considers the tractive resistance, is controlled to generate additional frictional braking force in consideration of insufficient braking force at the second time point in the third section. Thereafter, the current braking force, which is the sum of the tractive resistance, the maximum regenerative braking force, and the frictional braking force, is controlled to be equal to the target braking force at the respective time point. Then, the braking force required for the autonomous vehicle and the target braking force are equal to each other, such that an effect of solving braking heterogeneity and improving braking efficiency is achieved.

Referring to FIG. 6, the tractive resistance is decreased in the first to third sections as time passes. The autonomous vehicle is controlled to generate additional regenerative braking force at the first time point and controlled such that the current braking force and the target braking force are equal to each other by further adding the regenerative braking force corresponding to the decreased tractive resistance. In addition, the autonomous vehicle is controlled to generate additional frictional braking force at the second time point and controlled such that the current braking force and the target braking force are equal to each other by further adding the frictional braking force corresponding to the decreased tractive resistance. That is, according to the exemplary form of the present disclosure, the current braking force and the target braking force are equal to each other even though the tractive resistance is decreased in the braking section.

Of course, according to another exemplary form of the present disclosure, the current braking force may be controlled to be in a constant range based on the target braking force in the second section and the third section.

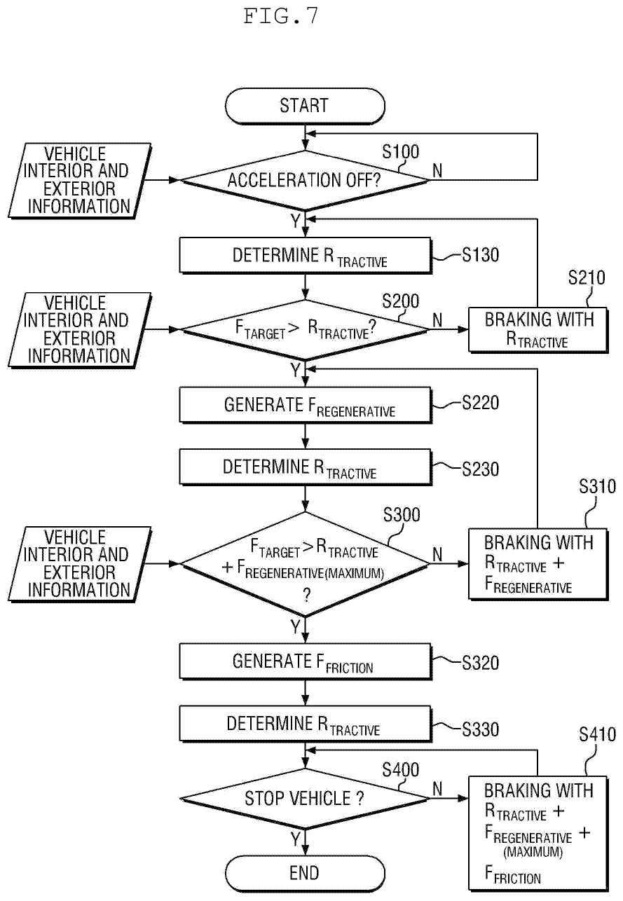

FIG. 7 is a flowchart illustrating a method of controlling and distributing regenerative braking force in an autonomous vehicle in consideration of tractive resistance according to the exemplary form of the present disclosure.

Hereinafter, a method of controlling and distributing regenerative braking force in an autonomous vehicle in consideration of tractive resistance according to the present disclosure will be described with reference to FIG. 7. In addition, in the following respective control processes, the tractive resistance, the regenerative braking force, or the frictional braking force is determined in real time.

First, whether the autonomous vehicle is accelerated is determined (S100). The determination of whether the vehicle is accelerated is performed to determine the braking start time point, and the determination of whether the vehicle is accelerated is performed based on the information from the information collecting unit 110. When the autonomous vehicle is not accelerated, it is determined that the time point is the braking start time point, and the determination of the tractive resistance at the braking start time point is initiated (S130). In addition, the braking map suitable for the current braking situation is selected, and the target braking force and the current braking force are compared.

Next, based on the information from the information collecting unit 110, whether the target braking force F_{TARGET} is higher than the tractive resistance R_{TRACTIVE} is determined (S200). When the target braking force is lower than the tractive resistance, the tractive resistance is determined as the current braking force, and the control is performed so that no separate braking force is generated (S210). However, when the target braking force is higher than the tractive resistance, the control is performed so that the regenerative braking force F_{REGENERATIVE} is generated (S220). Here, the regenerative braking force is controlled to be gradually increased. Meanwhile, the tractive resistance is still determined in real time (S230).

Next, based on the information from the information collecting unit 110, whether the target braking force is higher than the sum of the tractive resistance and the maximum regenerative braking force F_{REGENERATIVE(MAXIMUM)} is determined (S300). When the target braking force is lower than the sum of the tractive resistance and the maximum regenerative braking force, the sum of the tractive resistance and the regenerative braking force is determined as the current braking force (S310). However, when the target braking force is higher than the sum of the tractive resistance and the maximum regenerative braking force, the control is performed such that the frictional braking force F_{FRICTION} is generated (S320). Here, the frictional braking force is controlled to be gradually increased. Meanwhile, the tractive resistance is still determined in real time (S330).

Next, based on the information from the information collecting unit 110, whether the autonomous vehicle is stopped is determined (S400). When the autonomous vehicle is not stopped, the sum of the tractive resistance, the maximum regenerative braking force, and the frictional braking force is determined as the current braking force (S410), the tractive resistance is determined in real time, and the frictional braking force is still increased. With the above-mentioned processes, the control is ended if the autonomous vehicle is stopped.

The present disclosure has been described with reference to the limited exemplary forms and the drawings, but the present disclosure is not limited thereto. The described exemplary forms may be variously changed or modified by those skilled in the art to which the present disclosure pertains within the technical spirit of the present disclosure.

What is claimed is:

1. A method of controlling and distributing a regenerative braking force in an autonomous vehicle, where the autonomous vehicle controls a braking force distribution to meet a target braking force required at respective time points in consideration of a tractive resistance determined in real time in a braking section of an autonomous vehicle, the method comprising:
a first step of comparing, by a comparing unit, the tractive resistance and the target braking force in a section from an autonomous vehicle acceleration off time point to a first time point in the braking section; and
a second step of comparing, by the comparing unit, a sum of the tractive resistance and a maximum regenerative braking force with the target braking force in a section from the first time point to a second time point in the braking section,
wherein a braking force from the autonomous vehicle acceleration off time point to the first time point is controlled so that the tractive resistance is distributed, and a braking force from the first time point to the second time point is controlled so that a sum of the tractive resistance and the regenerative braking force is distributed.

2. The method of claim 1, wherein in comparing the tractive resistance and the target braking force, when the tractive resistance is greater than the target braking force, no regenerative braking force is generated.

3. The method of claim 1, wherein in the first step, when the target braking force is greater than the tractive resistance, the regenerative braking force is increased to meet the target braking force.

4. The method of claim 3, wherein in the first step, the regenerative braking force is increased based on an amount of change in the tractive resistance.

5. The method of claim 1, wherein the tractive resistance comprises at least one of a rolling resistance, an air resistance, or a gradient resistance.

6. The method of claim 1, wherein ambient environment information of the autonomous vehicle used to determine the tractive resistance is collected by using an internet of things (IOT) module.

7. The method of claim 1, wherein in the second step, when the target braking force is greater than the sum of the tractive resistance and the maximum regenerative braking force, a frictional braking force is increased to meet the target braking force.

8. The method of claim 7, wherein in the second step, the frictional braking force is increased based on an amount of change in the tractive resistance.

9. The method of claim 7, wherein a braking force from the second time point to an autonomous vehicle stop time point is controlled so that a sum of the tractive resistance, the maximum regenerative braking force, and the frictional braking force is distributed.

10. A system for controlling and distributing a regenerative braking force in an autonomous vehicle, the system comprising:
an information collecting unit configured to acquire information about an interior and an exterior of an autonomous vehicle;
a determination unit configured to determine a tractive resistance based on the information collected by the information collecting unit;
a comparison unit configured to compare the tractive resistance and a target braking force or compare a sum of the tractive resistance and a maximum regenerative braking force with the target braking force; and
a braking force determining unit configured to determine the tractive resistance as a braking force, determine a sum of the tractive resistance and a regenerative braking force as a braking force, or determine a sum of the tractive resistance, the maximum regenerative braking force, and a frictional braking force as a braking force based on a determination result of the comparison unit.
